(19) United States
(12) Patent Application Publication
(10) Pub. No.: US 2016/0154768 A1
(43) Pub. Date: Jun. 2, 2016

(54) METHOD AND APPARATUS FOR PROCESSING MEMO IN PORTABLE TERMINAL

(71) Applicant: SAMSUNG ELECTRONICS CO., LTD., Suwon-si, Gyeonggi-do (KR)

(72) Inventors: Seongjoon Jeon, Gyeonggi-do (KR); Jeongmin Lee, Gyeonggi-do (KR)

(73) Assignee: Samsung Electronics Co., Ltd., Gyeonggi-do (KR)

(21) Appl. No.: 14/904,006

(22) PCT Filed: Jul. 10, 2014
(86) PCT No.: PCT/KR2014/006223

§ 371 Date: Jan. 8, 2016

(30) Foreign Application Priority Data
Jul. 10, 2013 (KR) 10-2013-0080695

(51) Int. Cl. G06F 17/21; G06F 3/0488

(52) U.S. Cl. CPC G06F 17/212; G06F 3/0488

(57) ABSTRACT

A method and an apparatus for processing a memo in a portable terminal are provided. The method includes displaying a memo screen, detecting a memo input in the memo screen, processing the memo input to generate an image, adjusting a line spacing of the memo screen according to the image, and adjusting the image to a default line spacing.

### TECHNICAL FIELD

The present disclosure relates to a method and an apparatus for controlling an input in an electronic device. More particularly to, the present disclosure relates to a method and an apparatus for processing a memo.

### BACKGROUND ART

Portable terminals such as a smart phone and a tablet PC are continually diversifying their functions and improving conveniences in use. The portable terminal may be equipped with an electronic pen, and various input functions can be performed by using the electronic pen while executing, for example, a memo application.

editing a memo in the portable terminal is performed by inputting text in a fixed line. The method displays a memo editing screen in a display unit and uses the electronic pen in the screen while executing the memo application. In this case, an inconvenience is generated in editing a memo with the electronic pen because the size of memo line is small. In order to solve this inconvenience, the memo can be edited by enlarging the size of memo line; however another inconvenience is then generated because the amount of text editable in a page decreases. As described above, the related art method for editing a memo is performed in a state of a fixed narrow line, and thereby the shape of characters does not appear even. If the memo is edited by enlarging the size of the memo line, inconveniences are generated because larger contents of picture or text cannot be input in a page, and a new page must be added.

The above information is presented as background information only to assist with an understanding of the present disclosure. No determination has been made, and no assertion is made, as to whether any of the above might be applicable as prior art with regard to the present disclosure.

### DISCLOSURE OF INVENTION

### Technical Problem

Aspects of the present disclosure are to address at least the above-mentioned problems and/or disadvantages and to provide at least the advantages described below. Accordingly, an aspect of the present disclosure is to provide a method and an apparatus for automatically adjusting a line spacing by analyzing a size of a memo input trace if a memo input is detected while executing a memo application.

Another aspect of the present disclosure is to provide a method and an apparatus for adjusting a line spacing according to a memo input trace in a memo execution screen and processing the memo by moving the memo input trace to a default location of a memo line.

### Solution to Problem

In accordance with an aspect of the present disclosure, a method for processing a memo in a portable terminal is provided. The method includes displaying a memo screen, detecting a memo input in the memo screen, processing the memo input to generate an image, adjusting a line spacing of the memo screen according to the image, and adjusting the image to a default line spacing.

In accordance with another aspect of the present disclosure, an apparatus for processing a memo in a portable terminal is provided. The apparatus includes a display panel configured to display a memo execution screen, a touch panel configured to detect a memo input, and a control unit configured to process to generate an image according to the memo input if the memo input is detected, to adjust a line spacing according to the image, and to adjust the image to a default line spacing.

### Advantageous Effects of Invention

The present disclosure can provide a method and an apparatus for automatically adjusting a line spacing by analyzing a size of a memo input trace if a memo input is detected while executing a memo application.

The present disclosure can provide a method and an apparatus for adjusting a line spacing according to a memo input trace in a memo execution screen and processing the memo by moving the memo input trace to a default location of a memo line.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a portable terminal according to an embodiment of the present disclosure;

FIG. 2 is a flow chart illustrating a procedure of adjusting a line spacing of a memo execution screen according to an embodiment of the present disclosure;

FIGS. 3A and 3B are screen examples illustrating a method of adjusting line spacing according to an embodiment of the present disclosure;

FIGS. 4A and 4B are screen examples illustrating memo execution screens according to an embodiment of the present disclosure;

FIG. 5 is a flow chart illustrating a procedure of adjusting a line spacing in a memo execution screen according to another embodiment of the present disclosure; and

FIGS. 6A, 6B, 6C, and 6D are screen example illustrating a procedure of adjusting a line spacing in a memo execution screen according to an embodiment of the present disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some components in the accompanying drawings are emphasized, omitted, or schematically illustrated, and the depicted size of each component does not necessarily reflect the actual size. Therefore, the present disclosure is not limited to the relative sizes and distances illustrated in the accompanying drawings.

A method for inputting a memo includes a text mode, pen mode, formula mode, and figure mode. In the present disclosure, the method for inputting a memo is assumed to be the pen mode. Namely, the pen mode is assumed to be used for inputting a memo in a memo execution screen.

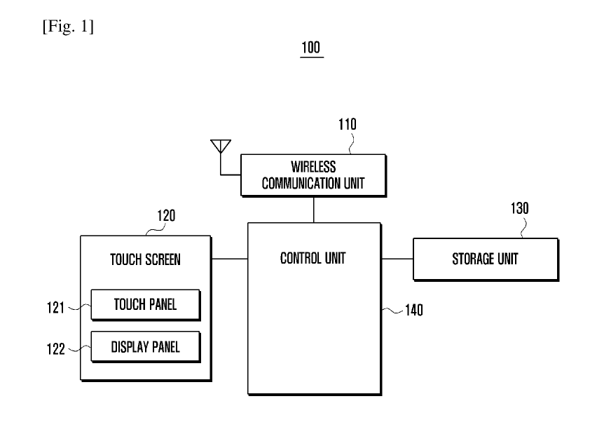

FIG. 1 is a block diagram illustrating a configuration of a portable terminal according to an embodiment of the present disclosure.

Referring to FIG. 1, the portable terminal 100 is configured with a wireless communication unit 110, touch screen 120, storage unit 130, and control unit 140.

The wireless communication unit 110 performs a voice communication or a data communication with an external device through a network under the control of the control unit 140. Further, the wireless communication unit 110 may include (not shown) a Radio Frequency (RF) transmitter for up-converting and amplifying the frequency of a transmitting signal, and an RF receiver for low-noise amplifying and down-converting the frequency of a received signal. The wireless communication unit 110 may include a mobile communication module (for example, Code Division Multiple Access (CDMA), Long Term Evolution (LTE), and Wideband CDMA (W-CDMA)), a digital broadcasting module (for example, Digital Multimedia Broadcasting (DMB) module), and a local area network communication module (for example, a WiFi module, BLUETOOTH module, and Near Field Communication (NFC) module).

The touch screen 120 may be configured with a touch panel 121 and a display panel 122. The touch panel 121 may be configured with the display panel 122 in an integrated form. In particular, the touch panel 121 according to the present disclosure can detect an input of an electronic pen or a finger generated in a memo execution screen. The touch panel 121 transmits a memo input trace detected under the control of control unit 140 to the control unit 140. The display panel 122 may be configured with a Liquid Crystal Display (LCD), Organic Light Emitting Diode (OLED), or Active Matrix Organic Light Emitting Diode (AMOLED). In particular, the display panel 122 according to the present disclosure displays a memo input trace by processing of an image under the control of control unit 140. Further, the display panel 122 can adjust and display a memo line under the control of control unit 140 so that the memo line fits the image size.

The storage unit 130 may be configured with (not shown) a program memory for storing an operating program of the portable terminal and a data memory for storing data generated or received during the execution of program. In particular, the storage unit 130 according to an embodiment of the present disclosure can store a memo data input through the memo execution screen. The storage unit 130 can store a memo adjusted (enlarged or reduced) to a predetermined size (ratio) under the control of the control unit 140.

The control unit 140 controls general operation of the portable terminal 100. In particular, the control unit 140 according to various embodiments of the present disclosure can display a memo execution screen for editing a memo in a memo application through the display panel 122. Further, if a pen input is detected in the memo execution screen, the control unit 140 can identify a location, size, and pattern of the memo input trace, and automatically adjust a line spacing of the memo execution screen.

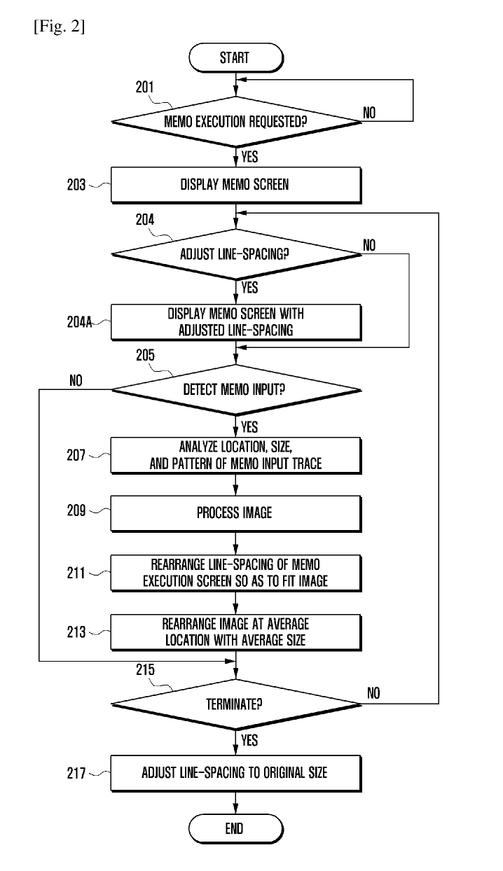

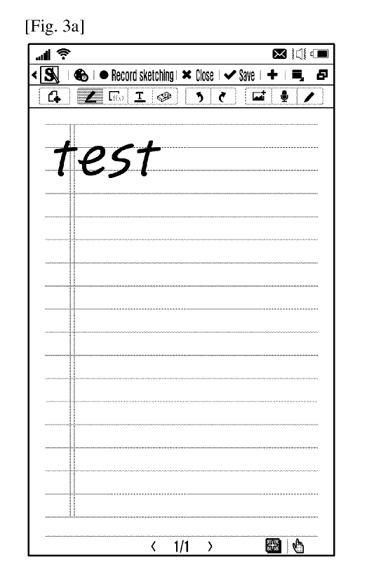

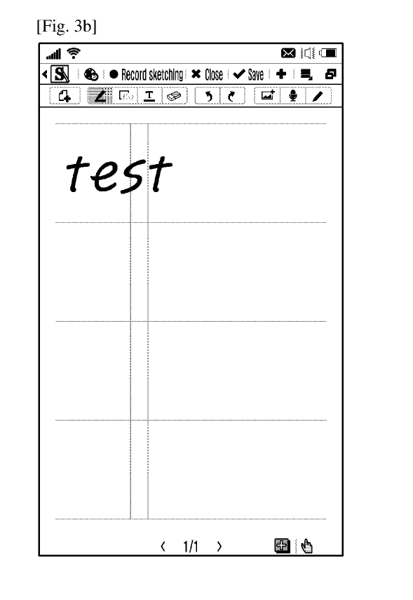

FIG. 2 is a flow chart illustrating a procedure of adjusting a line spacing of memo execution screen according to an embodiment of the present disclosure. FIGS. 3A and 3B are screen examples illustrating a method of adjusting line spacing according to the procedure of FIG. 2 according to an embodiment of the present disclosure.

Referring to FIG. 2, a method for adjusting a line spacing may be performed in the following order.

If a user selects a memo edit function, the control unit 140 detects a request for executing a memo at operation 201. If the request for executing the memo is detected, the control unit 140 executes a memo application and displays a memo execution screen in the display panel 122 at operation 203. The memo execution screen may be an execution screen for a pen dedicated mode, or may be set to a pen mode or a finger mode in a user setting procedure.

Here, the user can adjust a line spacing of the memo execution screen. Namely, the user may adjust a line spacing of a memo screen displayed in the display panel 122 while editing the memo. Generally, a line spacing of the memo screen displayed while inputting the memo may have a narrow width for inputting with a pen. In this case, the user must input in a small size of character by using the pen, and thereby the control unit 140 cannot correctly identify a memo input trace. Namely, when inputting a memo with a line spacing provided as default in the pen memo mode, the user may have an inconvenience in inputting a small character by using the pen, and the control unit 140 cannot correctly detect and display a memo input trace because the pen memo trace is too small. The user may adjust the line spacing of the memo screen to a desired size when inputting a pen memo. If the user selects a line spacing adjustment for the memo screen, the control unit 140 detects this at operation 204, and adjusts the line spacing of the memo screen to a predetermined line size at operation 204a. If the line spacing of the memo screen is adjusted to a bigger size, the user can input a memo in a bigger size by using the pen.

Subsequently, the control unit 140 determines whether a pen memo input is detected at operation 205 as shown by FIG. 3A. If the memo input is not detected, the control unit proceeds to operation 215 to determine the termination of editing, and terminates the memo application if an input for terminating the memo editing is detected. However, if a memo input is detected at operation 205, the control unit 140 identifies a location, size, and pattern of the memo input trace at operation 207, and processes the detected input to an image at operation 209. FIG. 3A illustrates an example of freely inputting a memo by the user in the memo execution screen.

Subsequently, the control unit 140 rearranges lines of the memo execution screen based on the processed image so as to fit the image at operation 211. If the line spacing is enlarged, the number of editable characters becomes smaller comparing to that of the basic line (for example, if the size of line is enlarged 2 times, the memo screen displayed in the display panel 122 may become ¼ comparing to that of the basic line). Accordingly the end of line of the memo screen displayed in the display panel 122 may not be the actual end of line.

Subsequently, the control unit 140 rearranges the image in an average size at an average location of the adjusted line at operation 213 as shown in FIG. 3B. Namely, after adjusting the line spacing so as to fit the image in the image processing procedure, the control unit 140 may control to rearrange the image. In the process of rearranging the image, the control unit 140 determines the average location so that the image does not exceed the adjusted line spacing. At the same time, the control unit 140 determines an average size of characters so that larger or smaller characters can be shown in an even size, and rearranges the image accordingly. If the termination of editing is not requested at operation 215, the control unit 140 controls the procedure to branch to operation 204. Thereafter, the control unit 140 detects additional memo inputs. If the termination of editing is requested at operation 215, the control unit 140 adjusts the line spacing back to the original size and stores the image at operation 217, and terminates the memo application.

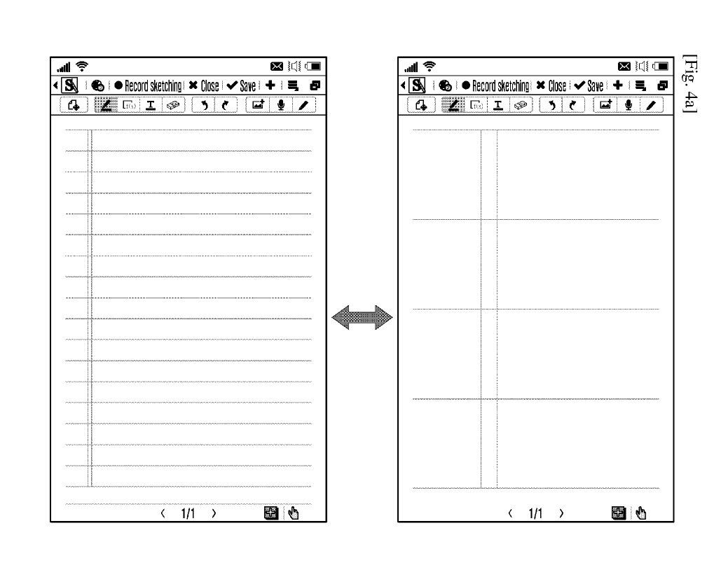

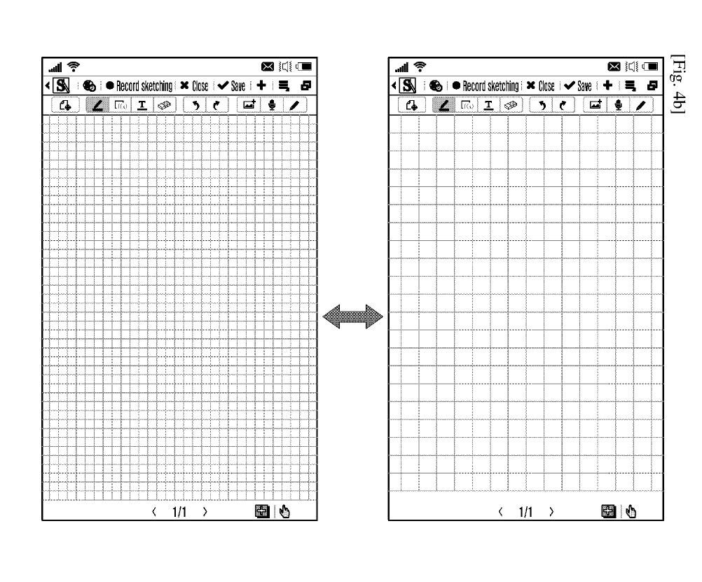

FIGS. 4A and 4B are screen examples illustrating memo execution screens according to an embodiment of the present disclosure.

FIG. 4A illustrates an example of memo execution screen in a note form. In the memo execution screen of FIG. 4A, the control unit 140 can adjust a fixed line spacing of a memo by using a pinch zoom method. By using the pinch zoom method, the control unit 140 can variously adjust the height and length of a line. For example, the control unit 140 can enlarge or reduce the memo execution screen by using the pinch zoom as shown by Table 1; however, the enlargement is not limited to the examples of Table 1.

TABLE 1

| Screen enlargement | Line spacing (cm) |
|---|---|
| 100% | 0.7 |
| 150% | 1 |
| 200% | 1.4 |
| 250% | 1.8 |

Referring to Table 1, the line spacing becomes wider as the screen enlargement increases. The display panel 122 can display a portion of the enlarged screen. If a memo input is detected in the enlarged screen, the control unit 140 can control to display the location of the detected memo input in the display panel 122. Namely, the control unit 140 can control to move the display panel 122 according to the location of the memo input.

FIG. 4B is a screen example illustrating a memo execution screen having grid lines. FIG. 4B illustrates an example of a memo execution screen switched from the form of FIG. 4A to a grid form. As shown in Table 2, the size of grid can be variously enlarged or reduced, however the screen enlargement is not limited to the examples of Table 2.

TABLE 2

| Screen enlargement | Grid size (cm) |
|---|---|
| 100% | 0.2 |
| 150% | 0.3 |
| 200% | 0.4 |
| 250% | 0.5 |

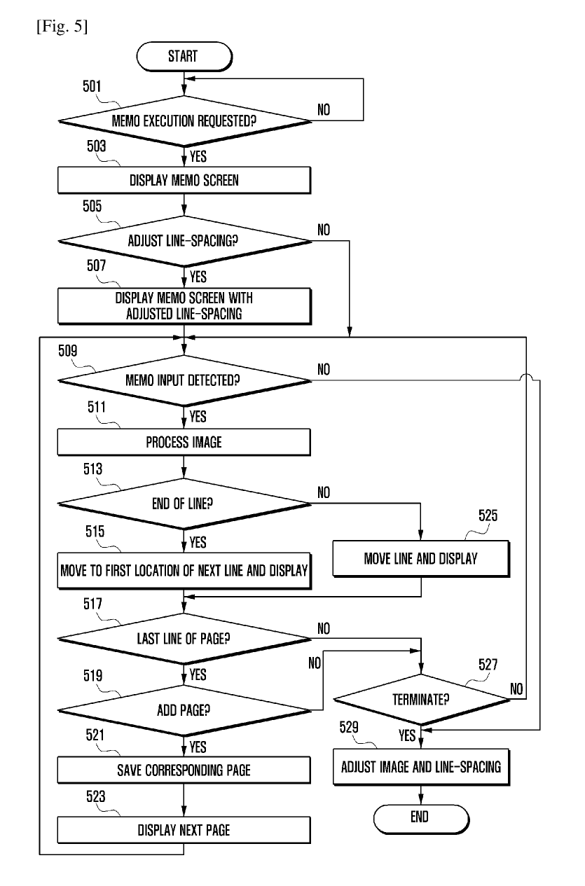

As shown in Table 2, the control unit 140 can set the line spacing of memo corresponding to the enlargement of the memo execution screen. The control unit 140 can identify a stored screen size, and display the screen with a size corresponding to the enlargement of the memo execution screen. Further, the control unit 140 can control to display the location of a detected memo input in the enlarged screen. Namely, the control unit 140 can control to move the screen horizontally, if there is an empty space at a side of the line in the process of detecting the memo input. Further, the control unit 140 can move the screen both horizontally and vertically so that the next line can be displayed, if the memo input reaches the end of line. Detailed descriptions on this will be made hereafter referring to FIG. 5.

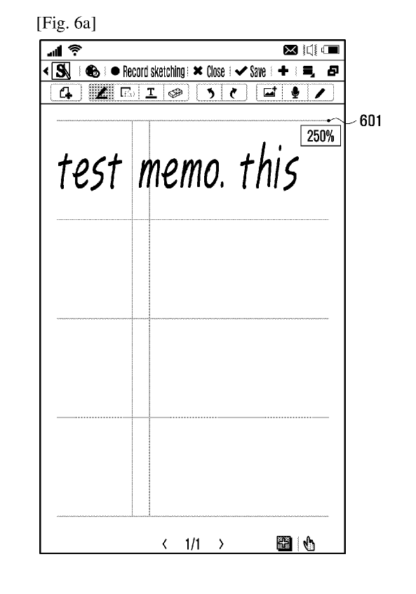

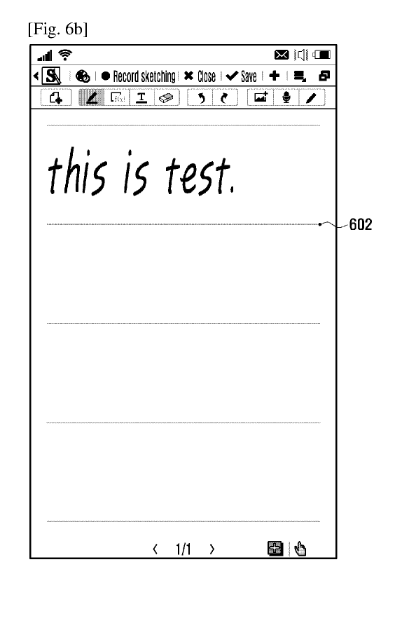

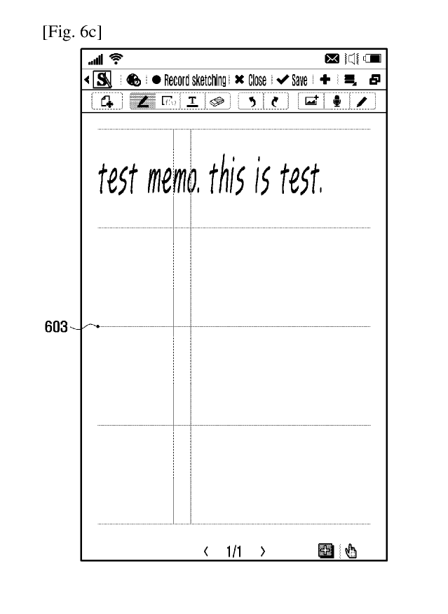

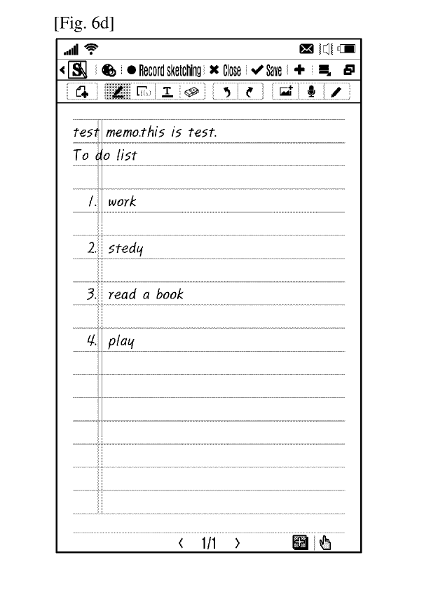

FIG. 5 is a flow chart illustrating a procedure of adjusting a line spacing in a memo execution screen according to another embodiment of the present disclosure. FIGS. 6A, 6B, 6C, and 6D are screen examples illustrating a procedure of adjusting a line spacing in the memo execution screen according to an embodiment of the present disclosure.

Referring to FIG. 5, a method for displaying a large amount of contents in a page by automatically adjusting the line spacing of the memo execution screen can be performed in the following order.

The control unit 140 determines whether a request for executing a memo application is generated at operation 501. If the request for executing a memo application is detected, the control unit 140 controls to display a memo execution screen in the display panel 122 at operation 503. The memo can be set so that various texts and images are inserted in a note form, grid form, and diary form. Hereinafter, the present disclosure assumes that the memo contents are input in the note form.

In the memo execution screen, the control unit 140 detects an adjustment of line spacing at operation 505. If the adjustment of line spacing is detected, the control unit 140 controls to display the adjusted line spacing in the memo execution screen at operation 507. FIG. 6A is an example of memo execution screen enlarged to 250%. (Referring to Table 1, the line spacing is increased to 1.8 cm.). If a memo input is detected at operation 509 as shown in the enlarged memo execution screen of FIG. 6A, the control unit 140 detects a memo, for example, “test memo. this”, and processes it to an image at operation 511. Namely, the touch panel 121 can detect a memo input in the memo execution screen under the control of control unit 140. The control unit 140 calculates a size, pattern, and location of the image transmitted in the image processing, and controls to temporarily store them in the storage unit 130. Subsequently, the touch panel 121 transmits the detected memo input to the control unit 140.

input reached the end of a line at operation 513. If the location of the detected memo input did not reach the end of line, the control unit 140 controls to display the image of the detected memo input by moving the line horizontally at operation 525. In the state of the memo execution screen enlarged to 250% as shown in FIG. 6A, the control unit 140 detects “this” from the memo, “test memo. this”, and determines whether the displayed location corresponds to the end of the line. If the location of line 601 is not at the end of line, the control unit 140 moves the line horizontally as shown in FIG. 6B, and controls to display the location of detected memo input. If the memo input is detected at the end of line at operation 513, the control unit 140 controls to move to the first location of the next line at operation 515. Namely, the display panel 122 displays the location moved horizontally and vertically under the control of control unit 140. FIG. 6B illustrates an example of memo execution screen in which the location of detected memo input reached the end of line 602 in a state of the enlarged memo screen. If the location 602 of the detected memo input reached the end of line as shown in FIG. 6B, the control unit 140 controls to display the location of the memo input as shown in FIG. 6C by moving to the first location 603 of the next line. Namely, the control unit 140 controls to move the location of the memo input from the end of line 602 to the first location 603 of the next line, by moving horizontally and vertically.

When displaying a character image generated by a pen drawing in the memo screen through the above procedure, the control unit 140 moves the memo screen horizontally or vertically so that next character can be input, if it has not reached the actual end of the line.

Returning to FIG. 5, the control unit 140 determines whether the location of the detected memo input reached the last line of a page at operation 517. If the location of the detected memo input did not reach the last line of the page, the control unit 140 determines whether a request for terminating the memo application is generated at operation 527, and stores the image by adjusting the line spacing to fit the image at operation 529 if the request for terminating the memo application was generated. Namely, if the last line of page has not been reached, the control unit 140 may adjust the image and line spacing to store the contents of the detected memo input in a page.

For example, when terminating the memo application in FIG. 6D, the control unit 140 adjusts the image size of the detected memo input in order to save in a page. Here, the control unit 140 adjusts the image size that is greater or smaller than a default size to be the default size by calculating the image size. Further, the control unit 140 controls to adjust the line spacing so that the line spacing fits the image. In this manner, the control unit 140 can control to automatically adjust the image of the detected memo input and the line spacing. Accordingly, the control unit 140 can display a greater amount of a memo in a page.

If the location of the detected memo input reached the last line of the page at operation 517, the control unit 140 determines whether to add a new page at operation 519, stores the previous page at operation 521, and controls to display the new page at operation 523. The control unit 140 then controls to input another memo in the new page through the above process. If the new page is not added at operation 519, the control unit 140 detects the termination of the memo editing at operation 527, and automatically adjusts the image and line spacing at operation 529.

The portable terminal according to various embodiments of the present disclosure enables to input more amounts of memo into a page through a memo execution screen. If a memo is input in the memo execution screen, the size and location of memo input trace can be identified. Therefore greater amounts of memo can be contained in a page by adjusting a line spacing of memo according to the memo input trace.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method for processing a memo in a portable terminal, the method comprising:
displaying a memo screen;
detecting a memo input in the memo screen;
processing the memo input to generate an image;
adjusting a line spacing of the memo screen according to the image; and
adjusting the image to the line spacing.

2. The method of claim 1, wherein the adjusting of the line spacing comprises displaying the memo screen by moving the memo screen horizontally in a line direction if the displayed memo screen is not located at an end position of a line, and by displaying the memo screen at a first position of a next line by moving the memo screen horizontally in the line direction and vertically in a newline direction if the displayed memo screen is located at the end position, and storing an inputted memo and adding a new page after reaching the end position of a last line of a page

3. The method of claim 1, wherein the adjusting of the image comprises displaying a text image by adjusting the line spacing if the text image exceeds the line spacing.

4. The method of claim 1, wherein the adjusting of the image comprises:
determining an adjusted line spacing when terminating the memo input; and
adjusting size of the image according to the adjusted line spacing.

5. The method of claim 1, wherein the adjusting of the image comprises displaying the image in a page when terminating the memo input.

6. The method of claim 1, wherein the detecting of the memo input comprises calculating a default size and a default location from a size and location of the image in the image processing.

7. The method of claim 1, wherein the adjusting of the image comprises determining an average location of the memo input and positioning the image in the adjusted line spacing accordingly, and wherein the adjusting of the image comprises determining an average size of characters of the memo input and adjusting sizes of corresponding characters in the input accordingly to be a same size.

8. The method of claim 1, wherein the adjusting of the line spacing comprises maintaining a size of the image according to the memo input and adjusting the line spacing according to the size of the image.

9. An apparatus for processing a memo, the apparatus comprising:
a display panel configured to display a memo execution screen;
a touch panel configured to detect a memo input; and
a controller configured to process to generate an image according to the memo input if the memo input is detected, to adjust a line spacing according to the image, and to adjust the image to a default line spacing.

10. The apparatus of claim 9, wherein the controller is configured to control to move the memo screen horizontally in a line direction if the displayed memo screen is not located at an end position of a line, and to move the memo screen horizontally in the line direction and vertically in a newline direction to a first position of a next line if the displayed memo screen is located at the end position and to store an inputted memo and to add a new page after reaching the end position of a last line of a page.

11. The apparatus of claim 9, wherein the controller is configured to adjust the image within the line spacing if the image exceeds the line spacing, and calculate a default size and a default location of the image in the procedure of adjusting the image.

12. The apparatus of claim 9, wherein the controller is configured to determine an adjusted line spacing if the memo inputting is terminated in the adjusting of the image, and adjust a size of the image according to the adjusted line spacing.

13. The apparatus of claim 9, wherein the controller is configured to adjust a size of the text image and the line spacing so that the inputted memo can be displayed in a page if the inputting of the memo is terminated.

14. The apparatus of claim 9, wherein the controller is configured to adjust the image by determining an average location of the memo input and positioning the image in the adjusted line spacing accordingly, and wherein the controller is configured to adjust of the image by determining an average size of characters of the memo input and adjusting sizes of corresponding characters in the input accordingly to be a same size.

15. The apparatus of claim 9, wherein the controller is configured to adjust the line spacing by maintaining a size of the image according to the memo input and adjusting the line spacing according to the size of the image.

16. A non-transitory, computer-readable storage medium storing one or more executable instructions that, when executed by one or more processors, cause the one or more processors to:
generate an image on a display panel according to a memo input if the memo input is detected by a touch panel;
adjust a line spacing according to an image; and
adjust the image to a default line spacing.

17. The non-transitory, computer-readable storage medium of claim 16, wherein the one or more executable instructions cause the one or more processors to control to move the memo screen horizontally in a line direction if the displayed memo screen is not located at an end position of a line, and to move the memo screen horizontally in the line direction and vertically in a newline direction to a first position of a next line if the displayed memo screen is located at the end position and to store an inputted memo and to add a new page after reaching the end position of a last line of a page.

18. The non-transitory, computer-readable storage medium of claim 16, wherein the one or more executable instructions cause the one or more processors to adjust the image within the line spacing if the image exceeds the line spacing, and calculate a default size and a default location of the image in the procedure of adjusting the image.

19. The non-transitory, computer-readable storage medium of claim 16, wherein the one or more executable instructions cause the one or more processors to determine an adjusted line spacing if the memo inputting is terminated in the adjusting of the image, and adjust a size of the image according to the adjusted line spacing.

20. The non-transitory, computer-readable storage medium of claim 16, wherein the one or more executable instructions cause the one or more processors to adjust a size of the text image and the line spacing so that the inputted memo can be displayed in a page if the inputting of the memo is terminated.
